(19) United States
(12) Patent Application Publication
(10) Pub. No.: US 2008/0268130 A1
(43) Pub. Date: Oct. 30, 2008

(54) Edible fat continuous spreads

(75) Inventors: Johannes Robert Bons, Vlaardingen (NL); Robertus Martinus M. Diks, Vlaardingen (NL); Chiara Garbolino, Vlaardingen (NL); Hindrik Huizinga, Vlaardingen (NL); Mattheus Adrianus Zuiderwijk, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a UNILEVER

(21) Appl. No.: 12/082,261

(22) Filed: Apr. 10, 2008

(30) Foreign Application Priority Data
Apr. 11, 2007 (EP) EP07105945

(51) Int. Cl. A23D 7/005

(52) U.S. Cl. 426/604; 426/603

(57) ABSTRACT

The invention relates to an edible fat continuous spread comprising from 5 to 85 wt % fat and from 0.1 to 20 wt % plant sterol wherein the plant sterol is present in the form of elongated crystals. The invention further relates to a process for the preparation of an edible fat continuous spread comprising plant sterol, said process comprising the mixing of a first mixture comprising triglyceride oil and plant sterol present in the form of elongated crystals with a second mixture comprising one selected from the group consisting of fat phase, water phase and mixtures thereof, to provide a third mixture.

### FIELD OF THE INVENTION

The invention relates to edible fat continuous spreads, in particular to edible fat continuous spreads comprising plant sterol.

### BACKGROUND PRIOR ART

The fat phase of margarine and similar edible fat continuous spreads is often a mixture of liquid fat or oil and fat which is solid at ambient temperatures. The solid fat, called structuring fat or hardstock fat, serves to structure the fat phase and helps to stabilise the emulsion.

The liquid fat or oil fraction typically comprises liquid unmodified vegetable oil such as soybean oil, sunflower oil, low erucic rapeseed oil (Canola), corn oil and blends of vegetable oils. Also marine type oils such as fish oil and algae oil may be used.

The structuring fat fraction typically comprises a blend of fats that are solid at ambient temperatures. Usually the structuring fat is made from naturally occurring hard fats such as tropical oils and animal fat or fats that are prepared by either partial or full hydrogenation of liquid oils optionally followed by interesterification with liquid oils. Structuring fats can also be obtained by the fractionation of fats, e.g. dry of wet fractionation of palm oil. By their very nature, structuring fats contain a relatively large proportion of saturated fatty acids (SAFA), e.g. short chain saturated fatty acids, as these fatty acids tend to make the fat solid at ambient temperatures.

From a nutritional point of view it is desirable to keep the SAFA level as low as possible as (high levels of consumption of) SAFA increases the risk of Coronary Heart Disease. Furthermore, as fat tends to have a greater energy density (energy per gram) than carbohydrates and proteins it may also be desirable to keep the overall fat level of a food product as low as possible. Hence, efforts have been made to find replacements for the traditional hardstock fats typically used in the preparation of e.g. edible fat continuous spreads.

For example, EP 897 671 B1 discloses the use of phytosterols or other high melting lipids as structuring agents that make it possible to avoid or minimize the use of saturated fat and other traditional structure-imparting ingredients in food products. The invention relates to an aqueous dispersion or emulsion comprising one or more high melting lipids having a mean size of 15 microns or lower and a non-sterol emulsifier, the w/w ratio of the emulsifier to high melting lipid in said aqueous phase being less than 1:2. An emulsifier is needed and the structuring agent is part of an aqueous dispersion or emulsion.

WO 98/19556 discloses fatty esters of stanol and sterol as texturizing agents as part of a texturizing composition to fully or partly replace the hardstock. The texturizing agent may be used to replace part or all of the conventional hardstock in fat blends to be used in fat containing products, e.g. spreads, margarines. Allegedly, the physical properties of the stanol and sterol fatty esters can be tailor-made by changing the fatty acid composition. The stanol and sterol need to be esterified with fatty acids.

Means to lower the amount of hardstock fat and hence the amount of SAFA in an edible fat continuous spread preferably are simple to prepare and/or do not need additives like e.g. emulsifiers.

When lowering the level of hardstock fat and/or replacing the hardstock fat with alternative structuring agents in an edible fat continuous spread, it is desirable that the spread has a good mouthfeel, e.g. the structure and/or the organoleptic properties of the spread are not influenced in a negative way, e.g. still have the required structure and organoleptic properties.

WO 03/043433 A1 describes prepared foods, such a fried snack foods, fortified with non-esterified phytosterols delivered in fats or oils that are essentially free of emulsifiers, and the utility of such phytosterols for stabilizing heated fats and oils against oxidation. The phytosterols have been recrystallized in vegetable oil. It is stated that the material when tasted has a surprisingly soft and agreeable mouth feel. There is no mentioning of structuring properties of the material.

US 2003/096035 describes the recrystallisation of sterols with triglycerides whereby elongated hexagonal crystals are formed. The obtained solution is used to contact or to be combined with a food product being fried, cooked or otherwise heated. Alternatively the phtosterols are added as separate ingredients in the preparation of a prepared food. The examples of this patent application show the inclusion of the recrystallised sterols for example in cooking oil and peanut butter and suggest (claim 1) the inclusion in triglyceride based food products comprising between 75 and 90 wt % of triglyceride-based oil. This document does not disclose or suggest the use of recrystallised sterols in spreads based on liquid oil and relatively low levels of structuring fat.

WO 2007/030570 relates to food compositions comprising a fat based composition comprising 25 to 75 wt % of triglycerides and 25 to 75 wt % of triglyceride recrystallised phytosterols. The food product may be a spread (claim 12). Although this document suggests the inclusion of sterols in spreads no teaching is provided that recrystallised sterols having an elongated crystal form can be included in fat continuous spreads based on liquid oil and limited amounts of structuring fat.

WO98/13023 discloses a product containing plant sterol, sweetening agent and water, without admixtures. Example 8 discloses the preparation of a water continuous spread. This document does not disclose the inclusion of elongated crystals of sterols into a fat continuous spread.

It is an object of the present invention to provide an edible fat continuous spread with a reduced level of hardstock fat. It is also an object of the invention to provide an edible fat continuous spread with reduced levels of SAFA. In addition it is an object of the invention to provide an edible fat continuous spread with reduced levels of hardstock and/or SAFA that has a good texture and mouthfeel.

### SUMMARY OF THE INVENTION

It was found that one or more of the above mentioned objects is attained by the use of plant sterol in the form of elongated crystals in the preparation of an edible fat continuous spread.

Surprisingly, it was found that plant sterol in the form of elongated crystals allows for the lowering of the hardstock fat in an edible fat continuous spread.

Accordingly in a first aspect the invention relates to an edible fat continuous spread being a water in oil emulsion comprising a water phase and a fat phase, wherein the fat phase comprises liquid oil and a structuring fat, said spread comprising 5 to 85 wt % fat and from 0.1 to 20 wt % plant sterol wherein the plant sterol is present in the form of elongated crystals and wherein the amount of structuring fat is from 0.1 to 10 wt %.

The invention also relates to a process for the preparation of an edible fat continuous spread.

### DETAILED DESCRIPTION OF THE INVENTION

Wt % is calculated on weight of total product unless otherwise specified. For the purpose of the invention ambient temperature is defined as a temperature between 15 and 25° C. The terms ‘oil’ and ‘fat’ are used interchangeably unless specified otherwise. The terms ‘plant sterol’ and ‘phytosterol’ are used interchangeably unless specified otherwise.

The edible fat continuous spread according to the invention comprises plant sterol present in the form of elongated crystals. That is, the plant sterol is largely present in the form of elongated crystals. Preferably all the plant sterol is present in the form of elongated crystals. For the purpose of the invention elongated crystals are crystals that have a longest dimension (x or y or z) that is considerably longer than the smallest dimension (x or y or z), i.e. at least 10 to 500 times longer. Preferably the longest dimension of the crystal is at least 20, preferably at least 50, more preferably at least 100 and most preferably at least 200 micrometer. The longest dimension is the greatest distance in a straight line across the crystal. The longest dimension of the elongated crystal can for example be determined by light microscopy. Preferably the elongated crystals have a needle like and/or platelet like shape, more preferably the elongated crystals have a platelet like shape. Generally the upper limit for the longest dimension is 5000 micrometer, preferably 4000 micrometer and more preferably 2000 micrometer.

The elongated crystals may be prepared by the re-crystallization of plant sterols from a solvent comprising dissolved plant sterols, e.g. after heating. Preferably the re-crystallized plant sterol is prepared by re-crystallization from a mixture comprising triglycerides and heat dissolved plant sterol, e.g. by heating the triglycerides and plant sterol until part or all plant sterol is dissolved followed by re-crystallization of the plant sterol from the mixture as it cools down.

Preferably the re-crystallization of the plant sterol from the mixture comprising triglycerides and heat dissolved plant sterol commences slowly, i.e. the mixture is allowed to cool down at a slow pace. The plant sterol crystals so obtained may be characterized as ‘elongated crystals’. These plant sterol crystals may be used as structuring agent according to the invention. Rapid cooling of the heated solution, e.g. crash cooling, is often not suitable as this may result in the formation of small grain like crystals which are not suitable for use as structuring agent according to the invention.

Preferably the mixture comprising triglyceride oil and the plant sterol is prepared by heating the triglycerides and plant sterol until all plant sterol is dissolved. Preferably the rate of cooling of the heated mixture of triglycerides and plant sterol is less than 2° C. per minute, more preferably the rate of cooling is between 0.1 and 2° C. per minute.

Suitable triglyceride oils include vegetable oils and blends thereof. Preferably the triglyceride oil is selected form the group consisting of soybean oil, sunflower oil, low erucic rapeseed oil (Canola), corn oil and mixtures thereof. Especially preferred are sunflower oil and triglyceride oil mixtures comprising sunflower oil.

Plant sterols can be classified in three groups, 4-desmethylsterols, 4-monomethylsterols and 4,4′-dimethylsterols. In oils they mainly exist as free sterols and sterol esters of fatty acids although sterol glucosides and acylated sterol glucosides are also present. There are three major phytosterols namely beta-sitosterol, stigmasterol and campesterol. Schematic drawings of the components meant are as given in “Influence of Processing on Sterols of Edible Vegetable Oils”, S. P. Kochhar; Prog. Lipid Res. 22: pp. 161-188.

The respective 5 alpha-saturated derivatives such as sitostanol, campestanol and ergostanol and their derivatives are also encompassed in the term plant sterol.

Preferably the plant sterol is selected from the group comprising β-sitosterol, β-sitostanol, campesterol, campestanol, stigmasterol, brassicasterol, brassicastanol or a mixture thereof. Suitable sources of plant sterols are for example derived from soy bean or tall oil.

In the context of this invention the term plant sterol refers to the free plant sterol, i.e. the non-esterified plant sterol, unless specified otherwise.

Plant sterols are difficult to formulate into food products in their free form due to their poor solubility in fats and immiscibility in water which may result in food products having poor organoleptic properties, e.g. a sandy mouth feel. This has been partially mitigated in the prior art by esterification of the plant sterol with fatty acids, but calls for additional processing steps and hence an increase in costs. It has also been described in the literature that by using very small plant sterol particles it may be possible to alleviate to a certain extend the negative impact of plant sterol on the organoleptic properties. Typically the size of such particles is in the order of tens of micron. Furthermore it has been described in the literature that the negative influence of plant sterol on the organoleptic properties in emulsions may be mitigated to a certain extend by emulsifying the plant sterol with emulsifier.

Edible fat continuous spreads according to the invention comprise from 5 to 85 wt % fat, preferably from 10 to 80 wt %, more preferably from 15 to 60 wt % and even more preferably from 20 to 50 wt %.

Edible fat continuous spreads according to the invention are water in oil emulsions that comprise a water phase and a fat phase. The fat phase comprises liquid oil and structuring fat (hardstock). The structuring fat structures the fat phase and helps to a stabilise the emulsion. The crystallization and melting properties of the structuring fat are important as they influence the stability of the emulsion, e.g. syneresis and plasticity, as well as the organoleptic properties, e.g. oral melting behaviour and flavour release.

It will be appreciated that the amount of structuring fat necessary for imparting structure to an emulsion depends on the total amount of fat phase, the kind of liquid fat, the structuring fat used and the desired structure. For a stable spread a certain amount of structuring fat is necessary. If the amount of structuring fat is to low, a stable emulsion may not be obtained and the resulting emulsion may not comprise the typical plasticity of a spread.

We have found that it is possible to replace part or all of the structuring fat with plant sterol present in the form of elongated crystals while maintaining an acceptable structure of the spread, e.g. plasticity, and organoleptic properties, e.g. good mouthfeel. Accordingly, edible fat continuous spreads of the invention comprise from 0.1 to 20 wt % plant sterol, wherein the plant sterol is present in the form of elongated crystals. Preferably the amount of plant sterols is from 2 to 15 wt %, more preferably from 4 to 10 wt % and most preferably from 6 to 8 wt %.

The amount of structuring fat in products of the invention is from 0.1 to 10 wt %, more preferably from 1 to 8 wt % and most preferably from 2 to 6 wt %.

Preferably the amount of emulsifier in the edible fat continuous spread is from 0.01 to 5 wt %, more preferably from 0.1 to 2 wt % and most preferably from 0.1 to 0.5 wt %.

When using plant sterol present in the form of elongated crystals there is no need for emulsifiers to emulsify the plant sterols to achieve acceptable organoleptic properties. Therefore, the amount of emulsifiers may be limited.

The following table illustrates a number of embodiments of the invention, all these embodiments are fat continuous spreads being a water in oil emulsion comprising a water phase and a fat phase, comprising plant sterols in the form of elongated crystals. In the table below for each embodiment the amount of liquid oil, the amount of plant sterol and the amount of structuring fat is indicated. Suitably but not necessarily in these embodiments the liquid fat can for example be sunflower oil, the structuring fat can for example be a refined interesterified mixture of 35 parts palm kernel and 65 parts palm oil stearine.

TABLE 1
Fat-continuous spreads according to the invention

| | wt % | | wt % | | wt % | |
|---|---|---|---|---|---|---|
| embodiment | liquid fat | | structuring fat | | free sterol | |
| 1 | 5-85 | wt % | 0.1-10 | wt % | 0.1-20 | wt % |
| 2 | 10-80 | wt % | 0.1-10 | wt % | 0.1-20 | wt % |
| 3 | 15-60 | wt % | 0.1-10 | wt % | 0.1-20 | wt % |
| 4 | 20-50 | wt % | 0.1-10 | wt % | 0.1-20 | wt % |
| 5 | 5-85 | wt % | 0.1-10 | wt % | 2-15 | wt % |
| 6 | 10-80 | wt % | 0.1-10 | wt % | 2-15 | wt % |
| 7 | 15-60 | wt % | 0.1-10 | wt % | 2-15 | wt % |
| 8 | 20-50 | wt % | 0.1-10 | wt % | 2-15 | wt % |
| 9 | 5-85 | wt % | 0.1-10 | wt % | 6-8 | wt % |
| 10 | 10-80 | wt % | 0.1-10 | wt % | 6-8 | wt % |
| 11 | 15-60 | wt % | 0.1-10 | wt % | 6-8 | wt % |
| 12 | 20-50 | wt % | 0.1-10 | wt % | 6-8 | wt % |
| 13 | 5-85 | wt % | 1-8 | wt % | 0.1-20 | wt % |
| 14 | 10-80 | wt % | 1-8 | wt % | 0.1-20 | wt % |
| 15 | 15-60 | wt % | 1-8 | wt % | 0.1-20 | wt % |
| 16 | 20-50 | wt % | 1-8 | wt % | 0.1-20 | wt % |
| 17 | 5-85 | wt % | 1-8 | wt % | 2-15 | wt % |
| 18 | 10-80 | wt % | 1-8 | wt % | 2-15 | wt % |
| 19 | 15-60 | wt % | 1-8 | wt % | 2-15 | wt % |
| 20 | 20-50 | wt % | 1-8 | wt % | 2-15 | wt % |
| 21 | 5-85 | wt % | 1-8 | wt % | 6-8 | wt % |
| 22 | 10-80 | wt % | 1-8 | wt % | 6-8 | wt % |
| 23 | 15-60 | wt % | 1-8 | wt % | 6-8 | wt % |
| 24 | 20-50 | wt % | 1-8 | wt % | 6-8 | wt % |
| 25 | 5-85 | wt % | 2-6 | wt % | 0.1-20 | wt % |
| 26 | 10-80 | wt % | 2-6 | wt % | 0.1-20 | wt % |
| 27 | 15-60 | wt % | 2-6 | wt % | 0.1-20 | wt % |
| 28 | 20-50 | wt % | 2-6 | wt % | 0.1-20 | wt % |
| 29 | 5-85 | wt % | 2-6 | wt % | 2-15 | wt % |
| 30 | 10-80 | wt % | 2-6 | wt % | 2-15 | wt % |
| 31 | 15-60 | wt % | 2-6 | wt % | 2-15 | wt % |
| 32 | 20-50 | wt % | 2-6 | wt % | 2-15 | wt % |
| 33 | 5-85 | wt % | 2-6 | wt % | 6-8 | wt % |
| 34 | 10-80 | wt % | 2-6 | wt % | 6-8 | wt % |
| 35 | 15-60 | wt % | 2-6 | wt % | 6-8 | wt % |
| 36 | 20-50 | wt % | 2-6 | wt % | 6-8 | wt % |

In another aspect the invention relates to a process for the preparation of an edible fat continuous spread comprising plant sterol, said process comprising the mixing of a first mixture comprising triglyceride oil and plant sterol present in the form of elongated crystals with a second mixture comprising one selected from the group consisting of fat phase, water phase and mixtures thereof, to provide a third mixture.

Thus, the edible fat continuous spread may be prepared according to any method known to the person skilled in the art of making fat continuous spreads comprising the mixing of a mixture comprising triglyceride oil and plant sterol present in the form of elongated crystals with a water phase, a fat phase or combinations thereof.

Preferably the mixture comprising triglyceride oil and plant sterol present in the form of elongated crystals is mixed with an emulsion comprising a water phase and a fat phase.

For example, a fat continuous spread may be prepared by providing a water phase comprising water and e.g. salt and preservatives, providing a fat phase comprising liquid oil and structuring fat, mixing of the water phase and the fat phase at elevated temperatures at which the fat is fully liquid, subjecting the resulting emulsion to one or more cooling and or working treatments, and mixing the treated emulsion with a mixture comprising triglyceride oil and plant sterol present in the form of elongated crystals, optionally followed by subjecting the resulting emulsion (now comprising plant sterol present in the form of elongated crystals) to one or more cooling and or working treatments.

One or more of the steps of a typical process for making an emulsion is usually conducted in a process that involves apparatus that allow heating, cooling and mechanical working of the ingredients, such as the churn process or the votator process. The churn process and the votator process are described in Ullmanns Encyclopedia, Fifth Edition, Volume A 16 pages 156-158.

Therefore, preferably the resulting mixture of the mixing of a mixture comprising triglyceride oil and plant sterol present in the form of elongated crystals, with a water phase, a fat phase or combinations thereof is subjected to at least one treatment selected from the group consisting of cooling treatment, mechanical working treatment and combinations thereof. This may for example be preferred if the temperature of the resulting mixture after mixing is such that part or all of the structuring fat is still liquid. It will be appreciated by the person skilled in the art that if the second emulsion is prepared at a temperature at which the structuring fat is solid further cooling and or working treatment is not necessary.

Preferably the mixture comprising triglyceride oil and plant sterol present in the form of elongated crystals is prepared by slow re-crystallization of plant sterol from a mixture comprising triglyceride oil and heat dissolved plant sterol as described herein.

After the re-crystallization of the plant sterol, the mixture comprising the triglycerides and re-crystallized plant sterol may be used as such. However, it may be preferred to dilute this mixture further with for example more triglycerides to get a mixture with the required concentration of plant sterol. Preferably this mixture does not contain structuring fat, i.e. the triglycerides (e.g. oil) used in this mixture are liquid at room temperature.

The temperature of the mixture comprising the triglycerides and re-crystallized plant sterol should preferably be kept at a temperature below 60° C. once the plant sterols are re-crystallized, e.g. the mixture comprising triglycerides and plant sterol in the form of elongated crystals should not be heated to temperatures above 60° C. This to prevent the plant sterol crystals from dissolving again and re-crystallizing uncontrolled, thereby forming unwanted plant sterol structures. On the other hand the temperature of the mixture comprising the triglycerides and re-crystallized plant sterol preferably is at least 20° C. to allow good processing. Hence, the temperature of the mixture comprising the triglycerides and re-crystallized plant sterol is preferably kept at a temperature between 20 and 60° C., more preferably 20 and 45° C. and even more preferably between 25 and 35° C.

When the mixture comprising the triglycerides and plant sterol in the form of elongated crystals is mixed with the fat phase, water phase or mixtures thereof, the temperature of the resulting mixture preferably does not exceed 60° C. However, it may be allowable that right after mixing, the temperature of the resulting mixture exceeds 60° C. if this is only for a short period, i.e. a period short enough to prevent the re-crystallized plant sterols from dissolving again.

The invention is now illustrated by the following non limiting examples.

### EXAMPLES

### General Method for Preparing a Low Fat Spread

The following method was used for the preparation of the low fat spreads according to examples 2 and 3 and comparative A. A mini-votator on lab-scale was used. The ingredients and amounts used are specified in Table 1.
(a) A fat phase (1) was prepared by mixing the ingredients.
(b) A water phase (2) was prepared by mixing the ingredients.
(c) A sterol slurry (3) was prepared according to example 1 with the ingredients listed in Table 1 for examples 2 and 3. For comparative example A, a sterol slurry (3) was prepared with the ingredients listed in Table 1 by mixing the free plant sterol powder as delivered by the supplier at ambient temperature with the sunflower oil.
(d) A premix (4) was prepared by mixing the fat phase (1) and the water phase (2) as prepared above in amounts according to Table 1. The premix was kept at 60° C. This premix was pasteurized, cooled to 25° C. and processed through a votator line with an AAAC sequence, operating at 1500 rpm (A units) and 2000 rpm (C unit).
(e) Subsequently the processed premix was mixed with the sterol slurry (3) (that had been kept at ambient temperature) as described above in amounts as listed in Table 1 to obtain a final mixture (5).
(f) The final mixture was processed through an A unit (1500 rpm) and a C unit (3000 rpm).
(g) The product so obtained had a temperature of 15° C. and was filled in tubs and stored at 5° C.

### Example 1

### Preparation of Triglyceride Recrystallized Plant Sterol Slurry

1. 70 parts of sunflower oil and 30 parts of free plant sterol (obtained from tall oil) were added to a steel can.
2. The mixture of sunflower oil and plant sterol was heated to a temperature of approximately 110° C. to dissolve the sterols in the oil.
3. The clear mixture was transferred to a steel jacketed vessel, where the temperature of the coolant was set to 20° C. The stirring speed was as high as possible, but making sure no air was entrapped. The mixture was stirred while cooling to 20° C.
4. Crystallized material on the vessel wall was manually scraped off and mixed in the bulk. This was done to ensure optimal heat transfer.
5. The stirring speed was regulated so that there was no entrapment of air.

### Example 2

### Low Fat Spread Prepared with Triglyceride Recrystallized Plant Sterol Slurry, Hardstock 5.1%

A low fat spread with a hardstock level of 5.1 wt % was prepared according to the general method for preparing a low fat spread as described above.

The spread obtained had a good texture, i.e. a good plasticity, and a good mouthfeel.

### Example 3

### Low Fat Spread Prepared with Triglyceride Recrystallized Plant Sterol Slurry, Hardstock 2.1%

A low fat spread with a hardstock level of 2.1 wt % was prepared according to the general method for preparing a low fat spread as described above. The spread obtained had a good texture, i.e. a good plasticity, and a good mouthfeel.

Comparative A: Low Fat Spread Prepared with Powdered Plant Sterols, Hardstock 5.1%

A low fat spread with a hardstock level of 5.1 wt % was prepared according to the general method for preparing a low fat spread as described above.

The spread obtained had a good texture, i.e. a good plasticity, but had a very bad mouthfeel.

Comparative B: Low fat spread, no plant sterols, hardstock 2.1%

To make a low fat spread (35 wt % fat on total weight of product) with a reduced amount of hardstock (2.1 wt % on total weight of product) the following set-up will be necessary.

94 parts of refined sunflower oil will be mixed with 5.5 parts of refined interesterified mixture of 35 parts palm kernel and 65 parts palm oil stearine. To this fat blend small parts of lecithin, monoglyceride and beta carotene solution will be added.

The water phase will be prepared by adding to 99 parts of water small amounts of salt, potassium sorbate and citric acid to obtain a water phase with a pH of 4.8.

A premix will be prepared by adding 65 parts of the above mentioned water phase and 35 parts of the fat phase and will be kept at 60° C. The premix will be processed through a votator line with an AAAC sequence, operating at 1500 rpm (A units) and 2000 rpm (C unit). The chilling will be set as low as possible, but above freezing point of water: A1 20° C., A2 10° C., A3 4° C. The line will be flushed with 100% sunflower oil before to trigger inversion in the C-unit.

With this line set-up it will be very hard to get the product to invert, the emulsion exiting the last C-unit will very likely be water-continuous. To achieve conversion, the minimum amount of solids to be present is 3%, which is hardly achievable. The experiment will fail to produce a reasonable yellow fat spread, i.e. a spread with a good plasticity. If inversion is achieved, the product exiting the C-unit will be as soft as mayonnaise and will not be stable at temperatures above 15° C.

TABLE 1
Ingredients and amounts (in parts) of prepared spreads.

| | | | Compar- | Compar- |
|---|---|---|---|---|
| Ingredient: | Example 2 | Example 3 | ative A | ative B |
| Fat phase (1): | | | | |
| Refined sunflower oil | 73 | 88 | 73 | 94 |
| Refined interesterified | 26.5 | 11 | 26.5 | 5.5 |
| mixture of: | | | | |
| 35 parts palm kernel; and | | | | |
| 65 parts palm oil | | | | |
| stearine. | | | | |
| Lecithin, monoglyceride | Small amounts. | | | |
| and beta carotene | | | | |
| solution. | | | | |
| Water phase (2): | | | | |
| Water | 99 | 99 | 99 | 99 |
| Salt, potassium sorbate | Small amounts. pH obtained was 4.8. | | | |
| and citric acid. | | | | |
| Sterol slurry (3): | | | | # |
| Sunflower oil | 70 | 70 | 70 | |
| Free plant sterols | 30 | 30 | 30 | — |
| Pre-mix (4): | | | | |
| The fat phase (1) | 25 | 25 | 25 | 35 |
| The water phase (2) | 75 | 75 | 75 | 65 |
| Final mixture (5): | | | | ## |
| Processed pre-mix | 76 | 76 | 76 | — |
| (AAAC sequence) | | | | |
| The sterol slurry | 24 | 24 | 24 | — |

# not present
## not applicable as no stable processed pre-mix will be obtainable.

TABLE 2
Parameters of prepared spreads.

| | | | | Comparative |
|---|---|---|---|---|
| | Example 2 | Example 3 | Comparative A | B # |
| Hardstock level | 5.1 wt % | 2.1 wt % | 5.1 wt % | 2.1 wt % |
| (wt %) | | | | |
| D3.3 | 4 | 6 | 3 | — |
| e-sigma | 1.7 | 1.8 | 1.2 | — |
| Mouthfeel | good | good | very bad | — |

# A stable low fat spread will not be obtainable for this product composition.

### Example IV

Examples 2-3 can suitably be repeated by using the above process and the above composition, wherein the amount of fat in the form of liquid oil such as refined sunflower can be varied. Equally the amount of structuring fat, preferably in the form of a refined interesterified mixture of 35 parts palm kernel and 65 parts palm oil stearine can be varied as indicated below. The amounts of sterol, preferably in the form of free plant sterol may equally be varied as indicated below.

The table below indicates preferred formulational embodiments:

1. An edible fat continuous spread being a water in oil emulsion comprising a water phase and a fat phase, wherein the fat phase comprises liquid oil and a structuring fat, comprising 5 to 85 wt % fat and from 0.1 to 20 wt % plant sterol wherein the plant sterol is present in the form of elongated crystals and wherein the amount of structuring fat is from 0.1 to 10 wt %.

2. Spread according to claim 1 wherein the amount of fat is from 10 to 80 wt %, preferably from 15 to 60 wt % and more preferably from 20 to 50 wt %.

3. Spread according to claims 1 wherein amount of structuring fat is from 1 to 8 wt % preferably from 2 to 6 wt %.

4. Spread according to claim 1 wherein the amount of plant sterol is from 2 to 15 wt %, preferably from 4 to 10 wt % and more preferably from 6 to 8 wt %.

5. Spread according to claim 1 comprising an emulsifier, wherein the amount of emulsifier is from 0.01 to 5 wt %, preferably from 0.1 to 2 wt % and more preferably from 0.1 to 0.5 wt %.

6. Spread according to claim 1 wherein the plant sterol is present as plant sterol obtained by slow re-crystallization of plant sterol from a mixture comprising plant sterol and triglyceride oil.

7. Process for the preparation of an edible fat continuous spread according to claim 1, said process comprising the mixing of a first mixture comprising triglyceride oil and plant sterol present in the form of elongated crystals with a second mixture comprising one selected from the group consisting of fat phase, water phase and mixtures thereof, to provide a third mixture.

8. Process according to claim 7 wherein the first mixture is prepared by slow re-crystallization of plant sterol from a mixture comprising triglyceride oil and heat dissolved plant sterol.

9. Process according to claim 7 wherein the second mixture is an emulsion comprising a fat phase and a water phase.
